(19) United States
(12) Patent Application Publication
(10) Pub. No.: US 2023/0236843 A1
(43) Pub. Date: Jul. 27, 2023

(54) ELECTRONIC APPARATUS AND CONTROL METHOD THEREOF

(71) Applicant: SAMSUNG ELECTRONICS CO., LTD., Suwon-si (JP)

(72) Inventors: Jungseung LEE, Suwon-si (KR); Huijin PARK, Suwon-si (KR)

(21) Appl. No.: 18/124,253

(22) Filed: Mar. 21, 2023

Related U.S. Application Data
(63) Continuation of application No. PCT/KR2021/011982, filed on Sep. 6, 2021.

(30) Foreign Application Priority Data
Sep. 21, 2020 (KR) 10-2020-0121501

(51) Int. Cl. G06F 9/445; G06F 9/50

(52) U.S. Cl. CPC G06F 9/445; G06F 9/5016

(57) ABSTRACT

Disclosed is an electronic apparatus including: a first memory; a second memory; and a processor configured to: load a plurality of processes of an application into the first memory, identify a process switched to an inactivated state among the plurality of processes loaded into the first memory, store data of the process switched to the inactivated state in an area of the second memory by a sequential access method, and load the data of the process stored in the area of the second memory into the first memory based on the process being restored from the inactivated state to an activated state.

### CROSS-REFERENCE TO RELATED APPLICATIONS

This application is a continuation of International Application No. PCT/KR2021/011982 designating the United States, filed on Sep. 6, 2021, in the Korean Intellectual Property Receiving Office and claiming priority to Korean Patent Application No. 10-2020-0121501, filed on Sep. 21, 2020, in the Korean Intellectual Property Office, the disclosures of which are incorporated by reference herein in their entireties.

### BACKGROUND

### Field

The disclosure relates to an electronic apparatus, in which a memory is efficiently utilized, and a method of controlling the same.

### Description of Related Art

To execute an application, there are required processes for loading various resources of the application into a memory and computing the loaded resources. When the performance of a system is insufficient to execute the application or when the resources of the application to be executed are large, the entry of the application slows down.

Because the usability of an application for a user is greatly affected by time taken to enter the application, various application preloading techniques are used in consideration of the user and platform conditions.

At a point in time when the system starts operating or when it is identified that a designated application is needed based on a user’s usage scenario, the application is preloaded.

However, there sources of the memory in the system are limited, and therefore the resources and data of the application that are not being actively used are moved to a swap device to secure the memory resources and then loaded from the swap device into the memory as necessary and used.

### SUMMARY

Embodiments of the disclosure provide an electronic apparatus, in which a memory is more efficiently used and an application is more quickly executed, and a method of controlling the same.

According to an example embodiment of the disclosure, there is provided an electronic apparatus including: a first memory; a second memory; and a processor configured to: load a plurality of processes of an application into the first memory, identify a process switched to an inactivated state among the plurality of processes loaded into the first memory, store data of the process switched to the inactivated state in an area of the second memory by a sequential access method, and load the data of the process stored in the area of the second memory into the first memory based on the process being restored from the inactivated state to an activated state.

The processor may be configured to: exclude a process to be switched to the inactivated state among the plurality of processes of the application loaded into the first memory from a scheduling target and switch the excluded process to the inactivated state.

The process switched to the inactivated state may comprise a first process, and the area of the second memory may comprise a first area of the second memory, and the processor may be configured to: store data of a second process of an application, which is loaded into the first memory and remains in the activated state without being switched to the inactivated state, in a second area of the second memory by a random access method.

The processor may be configured to load the plurality of processes of the application into the first memory based on preparation for executing the application.

The processor may be configured to identify that the preparation for executing the application has occurred based on at least one of spare capacity of the first memory, speed of the processor, or average usage of the processor.

The electronic apparatus may further include: an interface, and the processor may identify that an event has occurred based on an input received through the interface to execute the application.

The processor may be configured to: add the process, the data of which is stored in the area of the second memory, to a scheduling target based on the event, and restore the process to the activated state.

The processor may be configured to: identify whether a plurality of processes of the application are present in the first memory based on the event, and identify the area of the second memory, in which the data of the process is stored, based on the process, the data of which is absent in the first memory, among the plurality of processes.

According to an example embodiment, there is provided a method of controlling an electronic apparatus, including: loading a plurality of processes of an application into a first memory; identifying a process switched to an inactivated state among the plurality of processes loaded into the first memory; storing data of the process switched to the inactivated state in an area of a second memory by a sequential access method; and loading the data of the process stored in the area of the second memory into the first memory based on the process being restored from the inactivated state to an activated state.

The method may further include: excluding a process to be switched to the inactivated state among the plurality of processes of the application loaded into the first memory from a scheduling target, and switching the excluded process to the inactivated state.

The process switched to the inactivated state may comprise a first process, and the area of the second memory may comprise a first area of the second memory, and the method may further include: storing data of a second process of an application, which is loaded into the first memory and remains in the activated state without being switched to the inactivated state, in a second area of the second memory by a random access method.

The loading the plurality of processes of the application into the first memory may include loading the plurality of processes of the application into the first memory based on preparation for executing the application.

The method may further include: identifying that the preparation for executing the application has occurred based on at least one of spare capacity of the first memory, speed of the processor, or average usage of the processor.

The method may further include: identifying that an event has occurred based on an input received through the interface to execute the application.

The method may further include: adding the process, the data of which is stored in the area of the second memory, to a scheduling target based on restoring the process to the activated state.

The method may further include: identifying whether a plurality of processes of the application are present in the first memory based on the event; and identifying the area of the second memory, in which the data of the process is stored, based on the process, the data of which is absent in the first memory, among the plurality of processes.

According to an example embodiment, there is provided a non-transitory computer-readable recording medium having stored thereon a computer program which, when executed by a computer, causes an electronic device to perform a method of controlling the electronic apparatus, the method including: loading a plurality of processes of an application into a first memory; identifying a process switched to an inactivated state among the plurality of processes loaded into the first memory; storing data of the process switched to the inactivated state in an area of a second memory by a sequential access method; and loading the data of the process stored in the area of the second memory into the first memory based on the process being restored from the inactivated state to an activated state.

According to an example embodiment of the disclosure, a preloading state of an application is implemented while efficiently using the capacity of a memory, thereby quickly performing the operations of the application.

According to an example embodiment of the disclosure, a process is switched to an inactivated state, thereby stably swapping data.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram showing illustrating an example configuration of an electronic apparatus according to various embodiments;

FIG. 2 is a block diagram illustrating an example configuration of an electronic apparatus according to various embodiments;

FIG. 3 is a flowchart illustrating example operations of an electronic apparatus according to various embodiments;

FIG. 4 is a diagram illustrating example operations of an electronic apparatus according to various embodiments;

FIG. 5 is a diagram showing illustrating an example scheduling operation of an electronic apparatus according to various embodiments;

FIG. 6 is a flowchart illustrating example operations of an electronic apparatus according to various embodiments;

FIG. 7 is a diagram illustrating example operations of an electronic apparatus according to various embodiments;

FIG. 8 is a flowchart illustrating example operations of an electronic apparatus according to various embodiments;

FIG. 9 is a flowchart illustrating example operations of an electronic apparatus according to various embodiments; and

FIG. 10 is a flowchart illustrating example operations of an electronic apparatus according to various embodiments.

### DETAILED DESCRIPTION

Below, various example embodiments of the disclosure will be described in greater detail with reference to the accompanying drawings. In the drawings, like numerals or symbols refer to like elements having substantially the same function, and the size of each element may be exaggerated for clarity and convenience of description. However, the technical concept of the disclosure and its components and functions are not limited to those described in the following example embodiments. In the following descriptions, details about known technologies or components may be omitted if they unnecessarily obscure the gist of the disclosure.

In the following example embodiments, terms ‘first’, ‘second’, etc. are simply used to distinguish one element from another, and singular forms are intended to include plural forms unless otherwise mentioned contextually. In the following example embodiments, it will be understood that terms ‘comprise’, ‘include’, ‘have’, etc. do not preclude the presence or addition of one or more other features, numbers, steps, operation, elements, components or combination thereof. In addition, a ‘module’ or a ‘portion’ may perform at least one function or operation, be achieved by hardware, software or combination of hardware and software, and be integrated into at least one module. In the disclosure, at least one among a plurality of elements refers to not only all the plurality of elements but also both each one of the plurality of elements excluding the other elements and a combination thereof.

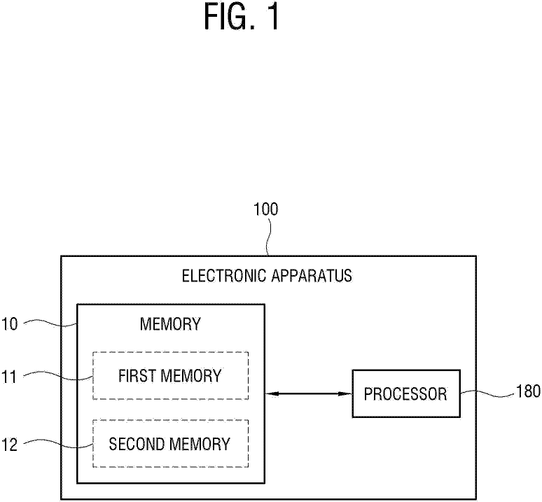

FIG. 1 is a block diagram illustrating an example configuration of an electronic apparatus according various embodiments.

An electronic apparatus 100 includes a memory 10. The memory 10 refers to a device configured to store or hold data or resources needed for executing an application or the like. The memory 10 may be classified based on, for example, whether it is volatile, accessing methods, the types of processes to be assigned thereto, etc. According to the disclosure, the memory 10 may be broadly classified into a first memory 11 and a second memory 12 according to whether it is volatile or not.

The first memory 11 is provided as a volatile memory in which data or resources(hereinafter collectively referred to as data) are temporarily stored or from which the temporarily stored data is read. In the volatile memory, the stored data is lost while powered off, such as when power is interrupted, the capacity is small compared to that of a nonvolatile memory, and a data execution speed is fast. Typically, the volatile memory includes a buffer, a random-access memory (RAM), and the like.

The second memory 12 is provided as a nonvolatile memory, in which stored information is continuously retained, e.g., data is permanently stored even while powered off. In the nonvolatile memory, the capacity is relatively large, and a data execution speed is slow. Typically, the nonvolatile memory includes a flash memory, a hard-disc drive (HDD), a solid-state drive (SSD), a read only memory (ROM), etc.

The electronic apparatus 100 includes a processor (e.g., including processing circuitry) 180.

The processor 180 may include one or more hardware processors implemented by a central processing unit (CPU), a chipset, a buffer, a circuitry, etc., which are mounted onto a printed circuit board (PCB), and may also be designed to be implemented as a system on chip (SOC).

According to an embodiment of the disclosure, the processor 180 loads an application stored in the second memory 12 into the first memory 11 to execute the application.

In this case, to execute an application more quickly, the processor 180 performs processes of loading and computing data in the first memory 11, which are required to execute the application, in advance and omits those processes when a user actually executes that application, thereby improving the usability of the application. This operation will be called ‘preloading’. When the preloading is performed, the data of the application executed in advance occupies the first memory 11.

However, the capacity of the first memory 11 may be limited, and therefore the processor 180 moves data, which is not being actively used, to the second memory 12 to secure the capacity, and reads and uses the data as necessary. An operation of storing the data that is not being currently used from the first memory 11 to the second memory 12 will be called ‘swap-out,’ and an operation of loading the swapped-out data back into the first memory 11 may be referred to as ‘swap-in.’

To execute the preloaded application, the processor 180 needs to perform the swap-in for the data swapped out to the second memory 12.

In this case, when the data to be read from the second memory 12 is randomly located in the second memory 12, it takes a long time to read the data.

Below, a method of efficiently performing input/output (I/O) operations when application data loaded into the first memory 11 for the preloading is swapped out to the second memory 12 for the memory efficiency will be described in greater detail.

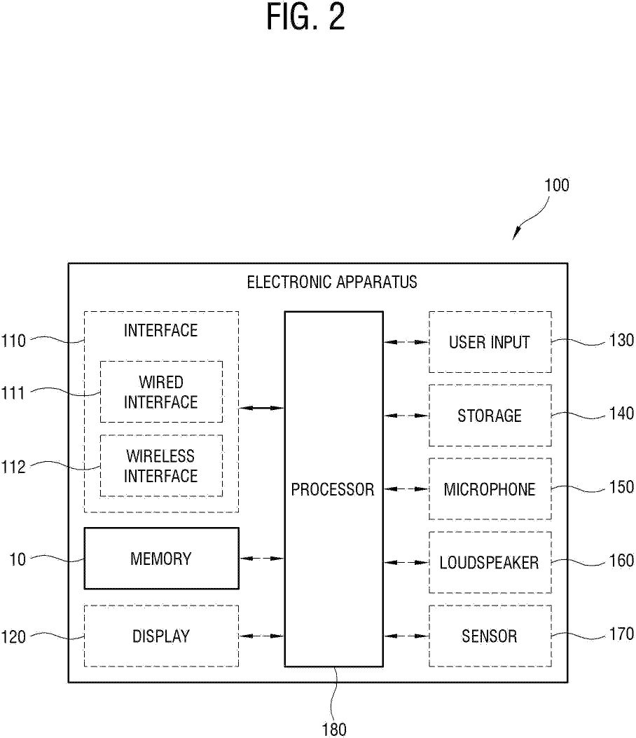

FIG. 2 is a block diagram illustrating an example configuration of an electronic apparatus according to various embodiments.

As shown in FIG. 2, the electronic apparatus 100 may include an interface (e.g., including various circuitry) 110.

The interface 110 may include a wired interface 111. The wired interface 111 may include a connector or port to which an antenna for receiving a broadcast signal based on a terrestrial/satellite broadcast or the like broadcast standards is connectable, or a cable for receiving a broadcast signal based on cable broadcast standards is connectable. The electronic apparatus 100 may include a built-in antenna for receiving a broadcast signal. The wired interface 111 may include a connector, a port, etc. based on video and/or audio transmission standards, like an HDMI port, Display Port, a DVI port, a thunderbolt, composite video, component video, super video, syndicat des constructeurs des appareils radiorécepteurs et téléviseurs (SCART), etc. The wired interface 111 may include a connector, a port, etc. based on universal data transmission standards like a universal serial bus (USB) port, etc. The wired interface 111 may include a connector, a port, etc. to which an optical cable based on optical transmission standards is connectable. The wired interface 111 may include a connector, a port, etc. to which an external microphone or an external audio device including a microphone is connected, and which receives or inputs an audio signal from the audio device. The wired interface 111 may include a connector, a port, etc. to which a headset, an earphone, an external loudspeaker or the like audio device is connected, and which transmits or outputs an audio signal to the audio device. The wired interface 111 may include a connector or a port based on Ethernet or the like network transmission standards. For example, the wired interface 111 may be embodied by a local area network (LAN) card or the like connected to a router or a gateway by a wire.

The wired interface 111 may be connected to a set-top box, an optical media player or the like external apparatus or an external display apparatus, a loudspeaker, a server, etc. by a cable in a manner of one to one or one to N (where, N is a natural number) through the connector or the port, thereby receiving a video/audio signal from the corresponding external apparatus or transmitting a video/audio signal to the corresponding external apparatus. The wired interface 111 may include connectors or ports to individually transmit video/audio signals.

Further, according to an embodiment, the wired interface 111 may be embodied as built in the electronic apparatus 100, or may be embodied in the form of a dongle or a module and detachably connected to the connector of the electronic apparatus 100.

The interface 110 may include a wireless interface 112. The wireless interface 112 may be embodied variously corresponding to the types of the electronic apparatus 100. For example, the wireless interface 112 may use wireless communication based on radio frequency (RF), Zigbee, Bluetooth, Wi-Fi, ultra wideband (UWB), near field communication (NFC) etc. The wireless interface 112 may be embodied by a wireless communication module that performs wireless communication with an access point (AP) based on Wi-Fi, a wireless communication module that performs one-to-one direct wireless communication such as Bluetooth, etc. The wireless interface 112 may wirelessly communicate with a server on a network to thereby transmit and receive a data packet to and from the server. The wireless interface 112 may include an infrared (IR) transmitter and/or an IR receiver to transmit and/or receive an IR signal based on IR communication standards. The wireless interface 112 may receive or input a remote-control signal from a remote controller or other external devices, or transmit or output the remote-control signal to other external devices through the IR transmitter and/or IR receiver. Alternatively, the electronic apparatus 100 may transmit and receive the remote-control signal to and from the remote controller or other external devices through the wireless interface 112 based on Wi-Fi, Bluetooth or the like other standards.

The electronic apparatus 100 may further include a tuner (not shown) to be tuned to a channel of a received broadcast signal, when a video/audio signal received through the interface 110 is a broadcast signal.

When the electronic apparatus 100 is embodied by a display apparatus, the electronic apparatus 100 may include a display 120. The display 120 includes a display panel for displaying an image on a screen. The display panel has a light-receiving structure including, for example, and without limitation, a liquid crystal type or a light-emitting structure like an OLED type. The display 120 may include an additional component according to the types of the display panel. For example, when the display panel is of the liquid crystal type, the display 120 includes a liquid crystal display (LCD) panel, a backlight unit for emitting light, a panel driving substrate for driving the liquid crystal of the LCD panel.

The electronic apparatus 100 may include a user input (e.g., including various input circuitry) 130.

The user input 130 transmits various preset control commands or unlimited information based on a user’s input to the processor 180. The user input 130 includes various input units for receiving a user’s input.

According to an embodiment, the user input 130 may include a key pad (or an input panel) including buttons such as a power key, a numeral key, and a menu key, which are provided in the electronic apparatus 100.

According to an embodiment, the user input 130 may include an input device that generates a preset command/data/information/signal for remotely controlling the electronic apparatus 100 and transmits the command/data/information/signal to the electronic apparatus 100. The input device may for example include a remote controller, a game console, a keyboard, a mouse, and the like, and receive a user’s input as being separated from the electronic apparatus 100.

The remote controller may include at least one button to receive a user’s input. According to an embodiment, the remote controller may include a touch sensor to receive a user’s touch input (or touch gesture) and/or a motion sensor to detect its own motion caused by a user. According to an embodiment, the input device may include a smart phone and the like terminal where a remote-control application is installed, and, in this case, a user may make a touch input through a touch screen.

The input device serves as an external apparatus capable of performing wireless communication with the main body of the electronic apparatus 100, and the wireless communication includes Bluetooth, infrared communication, radio frequency (RF) communication, wireless local area network (WLAN), WIFI direct, etc.

According to an embodiment, the user input 130 may include the motion sensor to detect a user’s hand motion, in other words, a hand gesture (hereinafter referred to as a gesture). The motion sensor of the electronic apparatus 100 may output data by detecting a moving distance, a moving speed, the area of a moving region, etc. of a hand.

According to an embodiment, the user input 130 may include the touch sensor to detect a user’s touch on a bezel region around a display 120.

According to an embodiment, the user input 130 may include a microphone 150 and the like sound receiver to receive a voice uttered by a user.

According to an embodiment, the user input 130 may receive a user’s input for a set distance that becomes a reference position for privacy processing of image data. For example, the user input 130 may receive a user’s input for setting or adjusting (changing) the set distance or a reference position corresponding to the set distance.

The electronic apparatus 100 may include a storage 140. The storage 140 is configured to store digitalized data. The storage 140 may include a nonvolatile storage which retains data regardless of whether power is on or off, and a volatile memory to which data to be processed by the processor 180 is loaded and which retains data only when power is on. The storage may include a flash– memory, a hard-disc drive (HDD), a solid-state drive (SSD) a read only memory (ROM), etc. and the memory includes a buffer, a random-access memory (RAM), etc.

The electronic apparatus 100 may include a microphone 150. The microphone 150 collects a sound of an external environment such as a user’s voice. The microphone 150 transmits a signal of the collected sound to the processor 180. The electronic apparatus 100 may include the microphone 150 to collect a user’s voice, or receive a voice signal from an external apparatus such as a smart phone, a remote controller with a microphone, etc. through the interface 110. The external apparatus may be installed with a remote-control application to control the electronic apparatus 100 or perform a function of voice recognition, etc. The external apparatus with such an installed application can receive a user’s voice, and perform data transmission/reception and control through Wi-Fi/BT or infrared communication with the electronic apparatus 100, and thus a plurality of interfaces 110 for the communication may be present in the electronic apparatus 100.

The electronic apparatus 100 may include a loudspeaker 160. The loudspeaker 160 may output a sound based on audio data processed by the processor 180. The loudspeaker 160 includes a unit loudspeaker provided corresponding to audio data of a certain audio channel, and may include a plurality of unit loudspeakers respectively corresponding to audio data of a plurality of audio channels. The loudspeaker 160 may be provided separately from the electronic apparatus 100, and in this case the electronic apparatus 100 may transmit audio data to the loudspeaker 160 through the interface 110.

The electronic apparatus 100 may include a sensor 170. The sensor 170 may detect the state of the electronic apparatus 100 or the surrounding states of the electronic apparatus 100, and transmit the detected information to the processor 180. The sensor 170 may include a camera.

The sensor 170 may include, but not limited to, at least one of a magnetic sensor, an acceleration sensor, a temperature/moisture sensor, an infrared sensor, a gyroscope sensor a positioning sensor (e.g., a global positioning system (GPS)), a barometer, a proximity sensor, and a red/green/blue (RGB) sensor (e.g., an illuminance sensor). It will be possible for those skilled in the art to infer the functions of the sensors from their names, and thus detailed descriptions thereof may not be provided.

The electronic apparatus 100 may include the processor 180. The processor 180 may include one or more hardware processors embodied by a CPU, a chipset, a buffer, a circuit, etc. mounted onto a printed circuit board, and may also be designed as a system on chip (SOC). The processor 180 includes modules corresponding to various processes, such as a demultiplexer, a decoder, a scaler, an audio digital signal processor (DSP), an amplifier, etc. when the electronic apparatus 100 is embodied by a display apparatus. Here, some or all of the modules may be embodied as the SOC. For example, the demultiplexer, the decoder, the scaler, and the like modules related to video processing may be embodied as a video processing SOC, and the audio DSP may be embodied as a chipset separated from the SOC.

When a voice signal of a user’s voice is obtained through the microphone 150 or the like, the processor 180 may convert the voice signal into voice data. In this case, the voice data may be text data obtained through a speech-to-text (STT) process of converting a speech signal into the text data. The processor 180 identifies a command indicated by the voice data, and performs an operation based on the identified command. Both the process of the voice data and the process of identifying and carrying out the command may be performed in the electronic apparatus 100. However, in this case, system load needed for the electronic apparatus 100 and required storage capacity are relatively increased, and therefore at least a part of the process may be performed by at least one server connected for communication with the electronic apparatus 100 through a network.

The processor 180 according to the disclosure may call and execute at least one instruction among instructions for software stored in a storage medium readable by the electronic apparatus 100 or the like machine. This enables the electronic apparatus 100 and the like machine to perform at least one function based on the at least one called instruction. The one or more instructions may include a code created by a compiler or a code executable by an interpreter. The machine-readable storage medium may be provided in the form of a non-transitory storage medium. The ‘non-transitory’ storage medium is tangible and may not include a signal (for example, an electromagnetic wave), and this term does not distinguish between cases where data is semi-permanently and temporarily stored in the storage medium.

Meanwhile, the processor 180 may perform at least a part of data analysis, processing, and result information generation through at least one of machine learning, a neural network, or a deep learning algorithm as a rule-based or AI algorithm to identify the process of the application loaded into the first memory and switched over from an activated state to an inactivated state, store the data of the process switched over to the inactivated state in the area of the second memory by a sequential access method, and to load the data of the process stored in the area of the second memory into the first memory in response to an event where the process is restored from the inactivated state to the activated state.

The processor 180 may identify the process of the application loaded into the first memory and switched over from an activated state to an inactivated state, store the data of the process switched over to the inactivated state in the area of the second memory by the sequential access method, and load the data of the process stored in the area of the second memory into the first memory in response to an event where the process is restored from the inactivated state to the activated state, thereby converting the loaded data into a form suitable to be used as an input of the AI model. The AI model may be made through learning. Here, a predefined operation rule or AI model set to have a desired characteristic (or purpose) is made by training a basic AI model through a plurality of learning data by a training algorithm. The AI model may include a plurality of neural network layers. Each of the plurality of neural network layers has a plurality of weight values, and perform neural network operations through an operation result of a previous layer and computation between the plurality of weight values.

The inference/prediction refers to technology of identifying information and logically making prediction, and includes knowledge/possibility-based inference, optimization prediction, preference-based planning, recommendation, etc.

For example, the processor 180 may function as a learner and a recognizer. The learner may perform a function of generating the trained neural network, and the recognizer may perform a function of recognizing (or inferring, predicting, estimating and identifying) the data based on the trained neural network. The learner may generate or update the neural network. The learner may obtain learning data to generate the neural network. For example, the learner may obtain the learning data from the storage 140 or from the outside. The learning data may be data used for the learning of the neural network, and the data subjected to the foregoing operations may be used as the learning data to train the neural network

Before training the neural network based on the learning data, the learner may perform a preprocessing operation with regard to the obtained learning data or select data to be used in learning among a plurality of pieces of the learning data. For example, the learner may process the learning data to have a preset format, apply filtering to the learning data, or process the learning data to be suitable for the learning by adding/removing noise to/from the learning data. The learner may use the preprocessed learning data for generating the neural network which is set to perform the operations.

The trained neural network may include a plurality of neural networks (or layers). The nodes of the plurality of neural networks have weight values, and the plurality of neural networks may be connected to one another so that an output value of a certain neural network can be used as an input value of another neural network. As an example of the neural network, there are a convolutional neural network (CNN), a deep neural network (DNN), a recurrent neural network (RNN), a restricted Boltzmann machine (RBM), a deep belief network (DBN), a bidirectional recurrent deep neural network (BRDNN) and deep Q-networks.

Meanwhile, the recognizer may obtain target data to carry out the foregoing operations. The target data may be obtained from the storage 140 or from the outside. The target data may be data targeted to be recognized by the neural network. Before applying the target data to the trained neural network, the recognizer may perform a preprocessing operation with respect to the obtained target data, or select data to be used in recognition among a plurality of pieces of target data. For example, the recognizer may process the target data to have a preset format, apply filtering to the target data, or process the target data into data suitable for recognition by adding/removing noise. The recognizer may obtain an output value output from the neural network by applying the preprocessed target data to the neural network. Further, the recognizer may obtain a stochastic value or a reliability value together with the output value.

For example, the method of controlling the electronic apparatus 100 according to the disclosure may be provided as involved in a computer program product. The computer program product may include instructions of software to be executed by the processor 180 as described above. The computer program product may be traded as a commodity between a seller and a buyer. The computer program product may be distributed in the form of a machine-readable storage medium (for example, a compact disc read only memory (CD-ROM)) or may be directly or online distributed (for example, downloaded or uploaded) between two user apparatuses (for example, smart phones) through an application store (for example, Play Store™) . In the case of the online distribution, at least a part of the computer program product may be transitorily stored or temporarily produced in a machine-readable storage medium such as a memory of a manufacturer server, an application-store server, or a relay server.

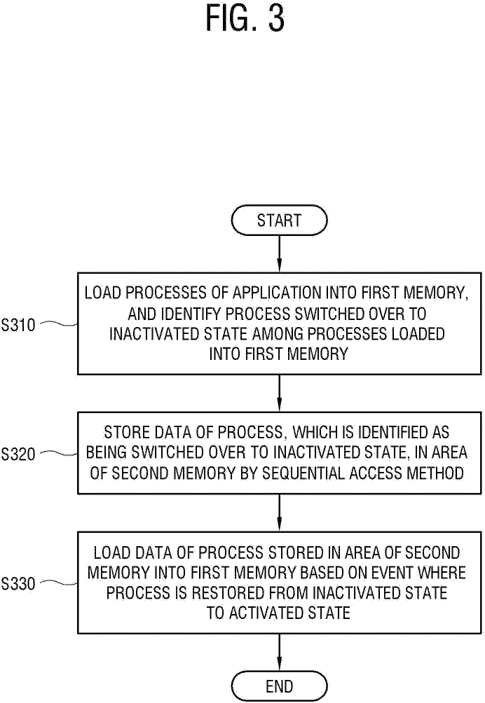

FIG. 3 is a flowchart illustrating example operations of an electronic apparatus according to various embodiments.

According to an embodiment of the disclosure, the processor 180 loads a plurality of processes of the application into the first memory 11, and identifies a process switched over to the inactivated state among the plurality of processes loaded into the first memory (S310).

According to an embodiment of the disclosure, the process may refer, for example, to a unit of jobs executed based on the data or application loaded into the memory 10. In other words, the application includes at least one process, and the processor 180 processes the data loaded into the memory 10, thereby performing one or more processes. Therefore, to execute a process, data corresponding to that process is required to be loaded into the memory 10, specifically, the first memory 11.

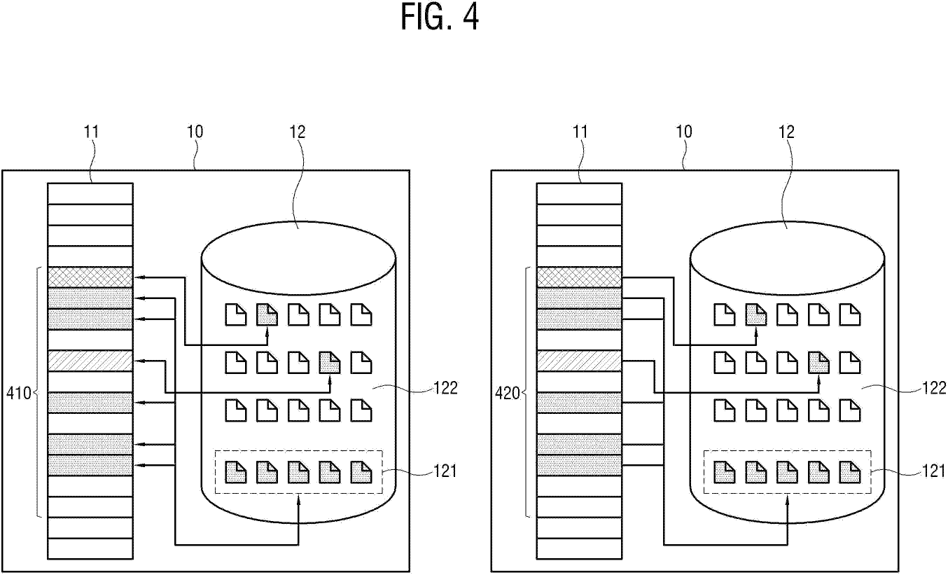

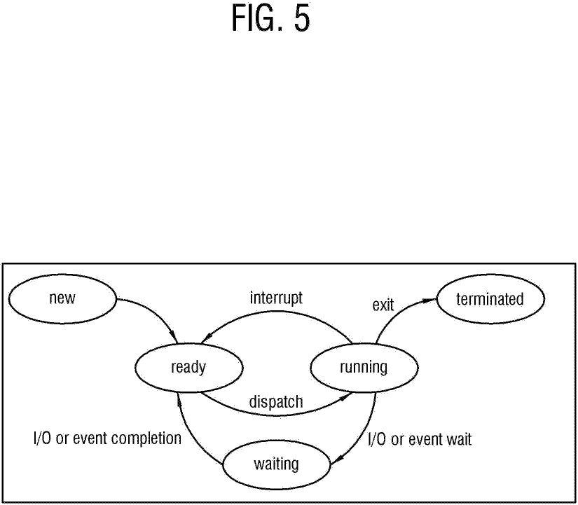

The processor 180 identifies the state of the process of the application. The activated state of the process refers to a state in which the data of the process is usable and freely movable by the processor 180 as necessary. On the other hand, the inactivated state refers to a state in which the data of the process is not in use and not freely movable by the processor 180 despite of occupying the memory. In this regard, details will be described with reference to FIGS. 4 and 5.

As described above with reference to FIG. 1, it will be assumed that the processor 180 has preloaded the application. Although the processor 180 swaps out the data to the second memory 12 in order to secure the capacity of the first memory 11, the application is still running in the background, and therefore the data moved to the second memory 12 may be reloaded into the first memory 11 during the operation of the processor 180.

When this operation is repeated, it is virtually meaningless to swap out the data to the second memory 12. Therefore, the processor 180 performs the swap-out from the first memory 11 to the second memory 12 based on the inactivated data, thereby efficiently using the capacity of the memory while implementing a preloaded state.

According to an embodiment of the disclosure, the processor 180 stores the data of the process, which is identified as being switched over to the inactivated state, in an area 121 of the second memory 12 by the sequential access method (S320).

The sequential access method refers to a method by which data is sequentially stored in a single area of a memory having continuous addresses and the area is sequentially accessed from the beginning at once to retrieve the data, and has a higher data I/O efficiency than a random access method by which data is divisionally stored in a plurality of random areas of a memory having discrete addresses and the plurality of areas are accessed several times to retrieve the data.

For example, the larger the capacity of the memory, the higher the I/O efficiency of the sequential access method. Generally, the sequential access method is 3 to 10 times faster in reading data than the random access method.

For example, when data is retrieved by the random access method, the area of the address where the data is located is randomly read in units of pages (4 KB). Therefore, the larger the size of the data, the more time it takes to find desired data. Accordingly, when the processor 180 needs to read a lot of data from the second memory 12 for a short period of time, the randomly stored data causes a bottleneck in the I/O operation, thereby decreasing the usability of the application. On the other hand, the sequential access method has larger data units and is faster to read the data because the data is stored in sequence.

To load data into the first memory 11 by the sequential access method as necessary later, the processor 180 sequentially stores the data in the area 121 of the second memory 12. The area 121 of the second memory 12 refers to a space having continuous addresses, and the size of the data to be stored in sequence is varied depending on the size of the area 121.

According to an embodiment of the disclosure, the processor 180 loads the data of the process stored in the area 121 of the second memory 11 into the first memory in response to an event where the process is restored from the inactivated state to the activated state (S330).

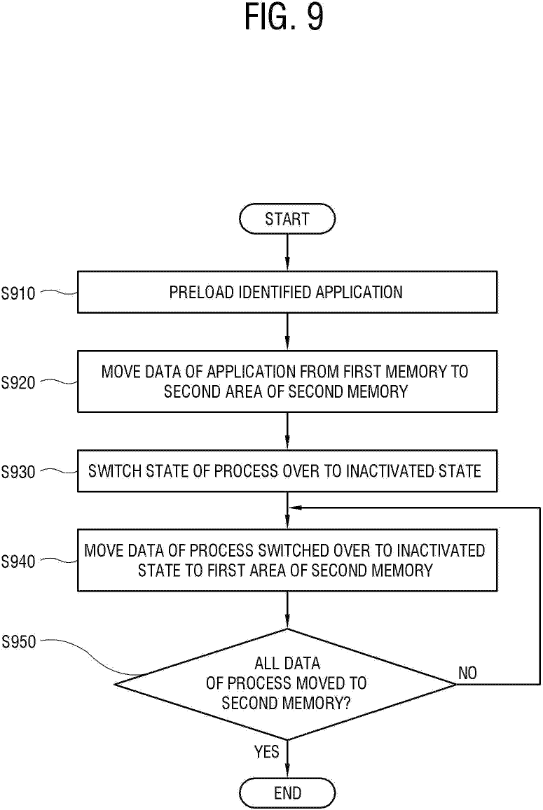

The event of restoration from the inactivated state to the activated state may for example be a user’s input for executing the application. This will be described in greater detail below with reference to FIG. 9.

The processor 180 loads the data of the process stored in the area 121 of the second memory 12 into the first memory 11 in response to the predetermined event. In this case, the data of the process is sequentially stored, so that the processor 180 can load the data stored in the area 121 of the second memory 12 into the first memory 11 at once, thereby quickly executing the application.

However, when the data is stored by the sequential access method, there is an advantage in terms of access speed, but there may be a restriction in terms of occupancy of a memory area. In other words, unlike the freely distributable area for the random access method, the area for the sequential access method needs to be secured in advance having a continuous space as large as all the data to be stored, and the secured area is restricted not to be used in storing other data. Therefore, for the efficient use of a memory space, careful consideration is required in designating the area for storing data by the sequential access method, and it is recommended to minimize and/or reduce the storage area for the sequential access method if possible.

Meanwhile, as described above, when the swap-out from the first memory 11 to the second memory 12 is performed based on the inactivated data, unintentional swap-in is prevented, thereby efficiently using the space of the memory.

Therefore, according to an embodiment of the disclosure, the processor 180 minimizes and/or reduces the area to be designated for the sequential access method in the first memory 11, switches the state of the process over to the inactivated state so as to prevent the data swapped out to the second memory 12 for the efficient use of that area from being unnecessarily reloaded into the first memory 11, and stores the data in the second memory 12 by the sequential access method.

Therefore, according to an embodiment of the disclosure, the capacity of the memory is efficiently used while preloading the application, thereby quickly performing the operations of the application.

FIG. 4 is a diagram illustrating example operations of an electronic apparatus according to various embodiments.

FIG. 4 illustrates an activated state in which the data of a process 410 is movable between the first memory 11 and the second memory 12 in the memory 10, as described above in the operation S310 of FIG. 3.

The processor 180 may move the data, which has been loaded into the first memory 11 for securing the capacity of the first memory 11, to the second memory 12, and move the moved data from the second memory 12 to the first memory 11 again by the execution of the processor 180. In other words, such a movable state of the data between the memories is called the activated state.

Therefore, to prevent the data, which has been swapped out from the first memory 11 to the second memory 12 for the efficiency of the memory, from being unnecessarily reloaded into the first memory 11, the processor 180 switches the state of the process over from the activated state to the inactivated state where the data is not movable between the memories, and stores the data in the second memory 12. The operation of switching over to the inactivated state will be described in greater detail below with reference to FIG. 5.

Further, FIG. 4 illustrates that the data of a process 420 is swapped out by the sequential access method or the random access method as described in the operation S320 of FIG. 3.

When the processor 180 moves the data of the process 420 from the first memory 11 to the second memory 12 in the case where the state of the process 420 is switched over to the inactivated state, the data is retained in the second memory 12 unless the processor 180 performs any separate operation.

The processor 180 identifies the spare capacity of the first memory 11, the speed of the processor 180, or the average usage of the processor 180, etc., and identify whether to swap out the data based on at least one among the spare capacity of the first memory 11, the speed of the processor 180, or the average usage of the processor 180, etc. For example, when the spare capacity of the first memory 11 is less than a predefined capacity, the processor 180 may identify that the swap-out to the second memory 12 is needed to secure the capacity of the first memory 11.

The second memory 12 may be divided into a first area 121 and a second area 122. The first area 121 refers to an area where data is sequentially stored, and the second area 122 refers to an area where data is randomly stored.

The first area 121 includes a plurality of sub areas provided (designated) for processes, respectively. Of course, a single process may be divisionally stored in a plurality of areas, but even in this case, the divided processes are sequentially stored in the areas.

The processor 180 switches the state of the data of the process 420 over to the inactivated state, and stores the data of the process 420, the state of which has been switched, in the first area 121 of the second memory 12 by the sequential access method. Of course, even in the inactivated state, the processor 180 may store the data of the process 420 in the second area 122 of the second memory 12 by the random access method. In this case, where and how to store the data of the process will be described below in greater detail with reference to FIG. 5. In addition, the processor 180 may store the data of the process of the application, which has been loaded into the first memory 11 and maintains the activated state without being switched over to the inactivated state, in the second area 122 of the second memory 12 by the random access method. By the random access method, the data of the process may be freely distributed and stored in the second area 122.

FIG. 5 is a diagram illustrating an example scheduling operation of an electronic apparatus according to various embodiments.

The processor 180 excludes the process, the state of which will be switched over to the inactivated state, among the plurality of processes of the application loaded into the first memory 11 from a running list, in other words, scheduling targets of the processor 180, and switches over the state of the excluded process into the inactivated state. For the scheduling targets, information indicating the states of the activated processes is stored and managed as shown in FIG. 5 in the form of a list. In other words, switching over to the inactivated state may refer, for example, to the processor 180 excluding or removing the activated process from the list of scheduling targets.

The process to be excluded from the scheduling targets, may for example include a process that is not used for a long period of time and having a low need to occupy the first memory 11, or a process that is essential for executing the application and needs to be stably stored in the second memory 12 so as to be loaded at once for fast execution.

Among the scheduling targets shown in FIG. 5, even a process in a ‘waiting’ state may take lower priority of usage than the process in a ‘running’ state. In this embodiment, the process excluded from the scheduling targets may have lower priority of usage than the process in the ‘waiting’ state.

FIG. 5 illustrates an example detailed procedure in which the processor 180 schedules the processes.

According to an embodiment of the disclosure, the process undergoes the following scheduling procedure before being restored to the activated state or switching over to the inactivated state by the processor 180.

First, a ‘new’ process is created, and the created process stays in a ‘ready’ state. The ready state refers to a state in which the processor 180 is scheduled to run. To switch over from the ready state to a ‘running’ state, a job scheduler needs to select that process.

‘Dispatch’ refers to transition from the ready state to the running state, and is performed as the job scheduler selects a corresponding process. The process executed at this time occupies the processor 180.

When an ‘interrupt’ signal is received, the running process is switched over to the ready state and a process having higher priority is switched over to the running state.

‘I/O or event wait’ refers to a condition that the process occupying the processor 180 needs to perform I/O processing, the running process is switched over from the running state to a waiting state. The process switched over to the waiting state stays in the waiting state until the I/O processing is completed. As the process in the running state is switched over to the waiting state, another process in the waiting state is switched over to the running state. In addition, the process in the waiting state may stay in an area of the first memory 11, or may be stored in the second area 122 by the random access method when it is swapped out to the second memory 12 but not inactivated.

In this case, as described above, the waiting state or the ready state in the scheduling procedure is one of the activated states operated by the processor 180, and distinguished from the inactivated state of the disclosure.

The process of ‘I/O or event completion’ is switched over from the waiting state to the ready state and thus selectable by the scheduler.

When the running state ends, the process is terminated.

The processor 180 may restore the process to the activated state by adding the process, the data of which is stored in the area of the second memory 12, to the scheduling targets in response to the event of the restoration

According to an embodiment of the disclosure, the data may be stably stored in the second memory 12 by switching the process over to the inactivated state.

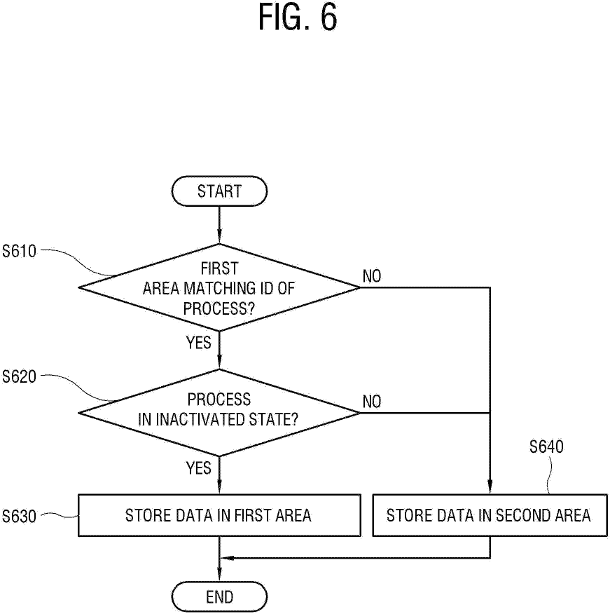

FIG. 6 is a flowchart illustrating example operations of an electronic apparatus according to various embodiments. FIG. 6 is a flowchart illustrating an example of implementing the operation S320 of FIG. 3.

When the data of process is swapped out from the first memory 11 to the second memory 12, the processor 180 identifies whether there is the first area 121 matching the ID of the process to be swapped out to the second memory 12 (S610) .

When there is the first area 121 matching the ID of the process (YES in S610), the processor 180 may continuously store the data of the process, which needs to be quickly swapped into the first memory 11 for executing the application later, in the second memory 12. On the other hand, when there is no first area 121 matching the ID of the process (NO in S610), the processor 180 randomly stores the data of process in the second area 122.

When there is the first area 121 matching the ID of the process (YES in S610), the processor 180 identifies whether the process is in the inactivated state(S620).

When the process is in the inactivated state (YES in S620), memory efficiency is expected in the swap-out because the data of the process stored in the second memory 12 by the processor 180 is hardly moved from the second memory 12 to the first memory 11. Further, the processor 180 stores the data of the process in the first area 121 by the sequential access method for the faster execution of the application including the process later (S630).

When the process is not in the inactivated state, e.g., when the process is in the activated state (NO in S620), the processor 180 stores the data of the process in the second area 122 of the second memory 12 by the random access method(S640).

In addition, regarding the operation S620, the processor 180 may identify whether the inactivated state is possible for the process (or a part of the process). When the inactivated state is possible, the process is inactivated and the data of the process is stored in the first area 121 (S630). When the inactivated state is impossible, the data of the process in the activated state is stored in the second area 122 (S640).

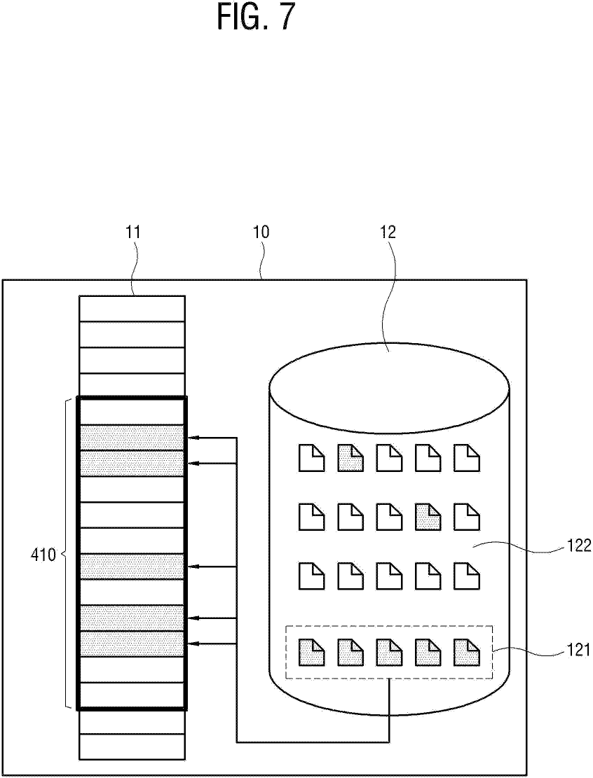

FIG. 7 is a diagram illustrating example operations of an electronic apparatus according to various embodiments.

As shown in the operation S330 of FIG. 3, FIG. 7 illustrates that the data stored in the first area 121 of the second memory 12 by the sequential access method is swapped into the first memory 11.

The processor 180 may load the data of the process 410 stored in the area of the second memory 12 into the first memory 11 in response to an event of restoration from the inactivated state to the activated state.

The event of the restoration from the inactivated state to the activated state may for example include a user’s input for executing the user’s application.

The electronic apparatus 100 according to an embodiment of the disclosure includes the interface 110, and the processor 180 may receive a user’s input for executing the application through the interface 110 and identify the event that the process 410 is restored to the activated state based on the received user’s input.

The user’s input may include an input for selecting an icon to execute an application in a graphic user interface (GUI) displayed on the display 120, or a voice input for executing an application.

In operation S620 of FIG. 6, when the process is stored in each area of the second memory 12 based on whether it is switched over to the inactivated state, the processor 180 may switch the process stored in the first area 121 to the activated state based on the event of the restoration from the inactivated state over to the activated state, and loads the activated process into the first memory 11. The processor 180 may load the process, which has been stored as the activated state in the second area 122, into the first memory 11 by switching the process being in the ready or waiting state over to the running state as shown in FIG. 5.

According to an embodiment of the disclosure, data is stored in the first area 121 of the second memory 12 by the sequential access method, so that the data stored in the first area 121 can be more quickly swapped in to the first memory 11 at once.

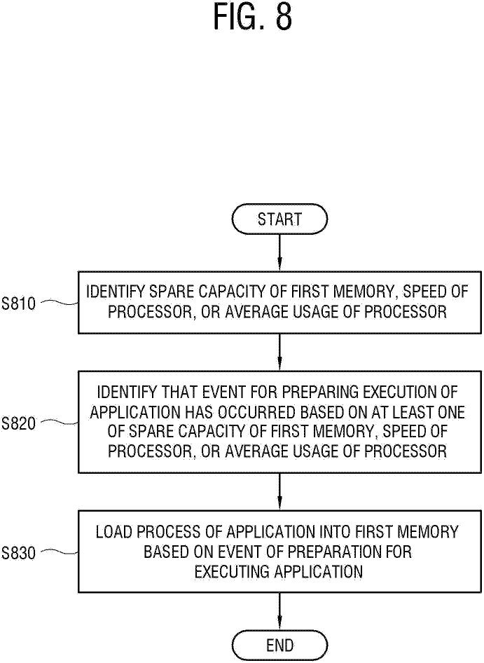

FIG. 8 is a flowchart illustrating example operations of an electronic apparatus according to various embodiments.

FIG. 8 illustrates that a plurality of processes of an application is loaded into the first memory 11 before the operation S310 of FIG. 3 is carried out.

According to the disclosure, the preloading refers to prior execution in the background of the processor 180 in preparation for later execution without a user’s separate execution, and the processor 180 identifies which application is to be executed at which point in time.

The processor 180 may identify the spare capacity of the first memory 11, the speed of the processor 180, or the average usage of the processor 180 (S810).

The processor 180 may identify that an event for preparing the execution of the application has occurred based on at least one of the spare capacity of the first memory 11, the speed of the processor 180, or the average usage of the processor 180 (S820).

For example, when the spare capacity of the first memory 11 is more than or equal to a predefined capacity, it is identified that there is room for executing an application not running but expected to run in addition to the application currently running in the first memory 11, and therefore the processor 180 may identify that the event for preparing the execution of the application has occurred.

The processor 180 may identify an application to be executed based on the frequency and time slot of using the application, the size of the application, etc.

The processor 180 may load a plurality of processes of the application into the first memory 11 based on an event of preparation for executing the application (S830).

According to an embodiment of the disclosure, the application to be preloaded may be identified to more efficiently implement the preloading and the memory use.

FIG. 9 is a flowchart illustrating example operations of an electronic apparatus according to various embodiments.

FIG. 9 illustrates another example that can be implemented by the electronic apparatus in connection with the operation S320 of FIG. 3.

The processor 180 may preload the application as it is identified based on FIG. 8 that the event of the preparation for executing the application has occurred (S910) .

The processor 180 may move the data of the process of the application from the first memory 11 to the second area 122 of the second memory 12 when the process is in the activated state as identified in the operation S620 of FIG. 6 (S920).

The processor 180 may switch the state of the process over to the inactivated state in order to store the data of the stable process in the second memory 12 (S930).

The processor 180 may move the data of the process switched over to the inactivated state to the first area 121 of the second memory 12 (S940).

The processor 180 identifies whether all the data of the process has been moved to the second memory 12 (S950). When all the data has not been moved (NO in S950), the processor 180 returns to the operation S940 and moves the remaining data to the first area 121 of the second memory 12. When all the data has been moved to the second memory 12 (YES in S950), the processor 180 terminates the operation.

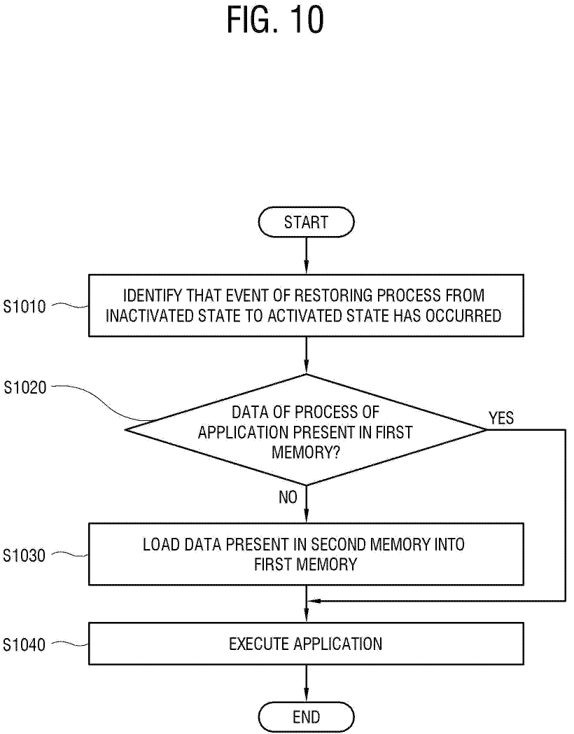

FIG. 10 is a flowchart illustrating example operations of an electronic apparatus according to various embodiments.

FIG. 10 illustrates operations in connection with the operation S330 of FIG. 3 after the processor 180 stably moves the data to the second memory 12.

The processor 180 identifies that an event of restoring a process from an inactivated state to an activated state has occurred (S1010). The restoration of the process from the inactivated state to the activated state may refer, for example, to the process being selected by the job scheduler to switch over from the ready state to the running state as described above with reference to FIG. 5. The selected process is executed and thus occupies the processor 180. The event of restoring the state of the process occurs as described above with reference to FIG. 7.

The processor 180 identifies whether a plurality of processes of the application is present in the first memory 11 in response to an event, in other words, based on a user’s input for executing the application (S1020)). When data for executing the application to be executed is present in the first memory 11 (YES in S1020), the processor 180 may execute that application based on the data (S1040) .

When the data of that application is moved to the second memory 12 for the preloading and the memory efficiency according to an embodiment of the disclosure, the processor 180 may identify some or all of the plurality of processes of the application are absent in the first memory 11 (NO in S1020). The processor 180 may receive a request (e.g., a page fault) that the application data is required.

Based on the process absent in the first memory 11 among the plurality of processes of the application, the processor 180 may identify the area of the second memory 12 in which the data of that process is stored.

The processor 180 may load the data present in the second memory 12 into the first memory 11 (S1030). In more detail, the processor 180 may load the data stored in the area of the second memory 12 into the first memory 11. The processor 180 may execute the application based on the loaded data (S1040). According to an embodiment of the disclosure, the execution of that application may refer, for example, to the application running in the background being switched to run in the foreground. The processor 180 switches the inactivated state of the process stored in the second memory 12 over to the activated state, and adds the activated process to the scheduling target, thereby operating the process in the running state.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic apparatus comprising:
a first memory;
a second memory; and
a processor configured to:
load a plurality of processes of an application into the first memory,
identify a process switched to an inactivated state among the plurality of processes loaded into the first memory,
store data of the process switched to the inactivated state in an area of the second memory by a sequential access method, and
load the data of the process stored in the area of the second memory into the first memory based on the process being restored from the inactivated state to an activated state.

2. The electronic apparatus of claim 1, wherein the processor is configured to: exclude a process to be switched to the inactivated state among the plurality of processes of the application loaded into the first memory from a scheduling target; and switch the excluded process to the inactivated state.

3. The electronic apparatus of claim 1, wherein
the process switched to the inactivated state comprises a first process, and the area of the second memory comprises a first area of the second memory, and
the processor is configured to: store data of a second process of an application, which is loaded into the first memory and remaining in the activated state without being switched to the inactivated state, in a second area of the second memory by a random access method.

4. The electronic apparatus of claim 1, wherein the processor is configured to load the plurality of processes of the application into the first memory based on preparation for executing the application.

5. The electronic apparatus of claim 4, wherein the processor is configured to: identify that the preparation for executing the application has occurred based on at least one of spare capacity of the first memory, speed of the processor, or average usage of the processor.

6. The electronic apparatus of claim 1, further comprising an interface, wherein
the processor is configured to identify that an event has occurred based on an input received through the interface to execute the application.

7. The electronic apparatus of claim 1, wherein the processor is configured to: add the process, the data of which is stored in the area of the second memory, to a scheduling target based on an event, to restore the process to the activated state.

8. The electronic apparatus of claim 1, wherein the processor is configured to:
identify whether a plurality of processes of the application are present in the first memory based on an event, and
identify the area of the second memory, in which the data of the process is stored, based on the process, the data of which is absent in the first memory, among the plurality of processes.

9. A method of controlling an electronic apparatus, comprising:
loading a plurality of processes of an application into a first memory;
identifying a process switched to an inactivated state among the plurality of processes loaded into the first memory;
storing data of the process switched to the inactivated state in an area of a second memory by a sequential access method; and
loading the data of the process stored in the area of the second memory into the first memory based on the process being restored from the inactivated state to an activated state.

10. The method of claim 9, further comprising
excluding a process to be switched to the inactivated state among the plurality of processes of the application loaded into the first memory from a scheduling target, and switching the excluded process to the inactivated state.

11. The method of claim 9, wherein the process switched to the inactivated state is a first process, and the area of the second memory is a first area of the second memory,
the method further comprising: storing data of a second process of an application, which is loaded into the first memory and remaining in the activated state without being switched to the inactivated state, in a second area of the second memory by a random access method.

12. The method of claim 9, wherein the loading the plurality of processes of the application into the first memory comprises loading the plurality of processes of the application into the first memory based on preparation for executing the application.

13. The method of claim 12, further comprising identifying that the preparation for executing the application has occurred based on at least one of spare capacity of the first memory, speed of the processor, or average usage of the processor.

14. The method of claim 9, further comprising identifying that an event has occurred based on an input received through the interface to execute the application.

15. The method of claim 9, further comprising: adding the process, the data of which is stored in the area of the second memory, to a scheduling target based on an event, and restoring the process to the activated state.
